(19) United States
(12) Patent Application Publication
(10) Pub. No.: US 2021/0314903 A1
(43) Pub. Date: Oct. 7, 2021

(54) SYSTEMS AND METHODS FOR COMMUNICATION NETWORK PRIORITIZATION BASED ON EXISTING NETWORK LOCATION IDENTIFICATION OF AN INFORMATION HANDLING SYSTEM

(71) Applicant: Dell Products, LP, Round Rock, TX (US)

(72) Inventors: Jace W. Files, Round Rock, TX (US); Liam B. Quinn, Austin, TX (US); Abu S. Sanaullah, Austin, TX (US)

(73) Assignee: Dell Products, LP, Round Rock, TX (US)

(21) Appl. No.: 16/841,426

(22) Filed: Apr. 6, 2020

(51) Int. Cl. H04W 64/00; G01S 19/05; G01S 19/45; H04B 17/318

(52) U.S. Cl. CPC H04W 64/003; H04B 17/318; G01S 19/45; G01S 19/05

(57) ABSTRACT

An information handling system, may include a processor; a memory device; a wireless network interface device to communicatively couple the information handling system to a communication network; a location module to determine the location of the information handling system relative to access points within a 4G LTE communication network and a WiFi communication network; a control management module to receive data descriptive of a location of a 5G new radio (NR) access point relative to the access points within the 4G LTE communication network and the WiFi communication network; and a communication redirection module to switch a communication connection from the access point within one of the 4G LTE communication network and WiFi communication network to the 5G NR access point.

### FIELD OF THE DISCLOSURE

The present disclosure generally relates to information handling systems communicatively coupling to a communication network. The present disclosure more specifically relates to communicatively coupling an information handling system to a 5G mm-wave communication network based, at least partially, on the location identification of the information handling system within a signal radius of the 5G mm-wave communication network via existing networks.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities including 5G millimeter-wave (mm-wave) communications.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a graphical diagram illustrating an information handling system interfacing with a plurality of access points according to an embodiment of the present disclosure;

FIG. 3 is a block diagram of a network environment offering several wireless communication protocol options and mobile information handling systems according to an embodiment of the present disclosure;

FIG. 4 is a block diagram of a network to redirect a network communication to a 5G new radio (NR) communication network according to an embodiment of the present disclosure; and

FIG. 5 is a flow diagram illustrating a method of prioritizing communication with a 5G new radio (NR) communication network according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

Embodiments of the present disclosure provide for an information handling system that allows for the dynamic communicative coupling of an information handling system to a 5G new radio (NR) communication network using information gathered from other networks such as a private long-term evolution (LTE) communication network, a public LTE network, a public WiFi communication network, a private communication network, among other types of communication networks. The data gathered and received by the information handling system includes data descriptive of the location of the information handling system within one or more of these types of communication networks. By identifying the location of the information handling system within the communication network, the information handling system may further receive data descriptive of the location of the information handling system relative to an access point associated with the 5G NR communication network. As such, the information handling system may reduce the amount of power consumed by the information handling system by limiting the power used to scan for 5G millimeter (mm)-wave access points in order to establish the communication with a 5G NR access point. Alternative existing networks may be used for location identification which require less power to wirelessly connect with the information handling system. Additionally, the data received by other communication networks apart from the 5G NR communication network, the data may be used to anticipate when the information handling system may be communicatively coupled to the 5G NR communication network based on the trajectory/velocity of the information handling system within the other communication network.

During operation, the information handling system may receive data descriptive of the location, trajectory, and/or velocity of the information handling system from a control management service associated with any non-5G NR communication network. During this time, the 5G mm-wave antenna at the information handling system may be maintained in an off state in order to reduce the power consumption associated with activating that antenna system. The management service associated with any non-5G NR communication network may aggregate any 4G and WiFi network data and send this relevant information to the information handling system. Among this relevant data, the information handling system may receive data descriptive of the physical location of a 5G NR access point relative to the information handling system. In this embodiment, the management service may utilize a triangulation process that identifies the location of the information handling system and, in some embodiments, the location of the information handling system relative to any access point within the 4G or WiFi communication networks described herein. Existing network access points may have known positions relative to 5G new radio (NR) access points (APs). As the information handling system approaches a signal radius of a 5G NR access point, the information handling system may activate its 5 mm-wave antenna system in order to switch data connection from an existing 4G or WiFi communication network to the 5G NR access point associated with that 5G mm-wave communication network. Scanning for 5G network connections and directionality determinations to ensure optimal connections to one or more in-range 5G NR APs may be power consuming and may be conducted more efficiently when location of an information handling system is known from another existing network type. When a signal strength (e.g., RSSI) between the information handling system and the 5G NR access point falls below a threshold, the wireless network interface device of the information handling system may automatically switch data connection from the 5G NR access point to a 4G or WiFi access point depending on which is available for use by the information handling system. Further, location of the information handling system may be continuously or iteratively monitored for assessment of other potential 5G NR APs.

In an embodiment, an information handling system may include a processor; a memory device; a wireless network interface device to communicatively couple the information handling system to a communication network; a location module to determine the location of the information handling system relative to access points within a 4G LTE communication network and a WiFi communication network; a control management module to receive data descriptive of a location of a 5G new radio (NR) access point relative to the access points within the 4G LTE communication network and the WiFi communication network; and a communication redirection module to switch a communication connection from the access point within one of the 4G LTE communication network or WiFi communication network to the 5G NR access point.

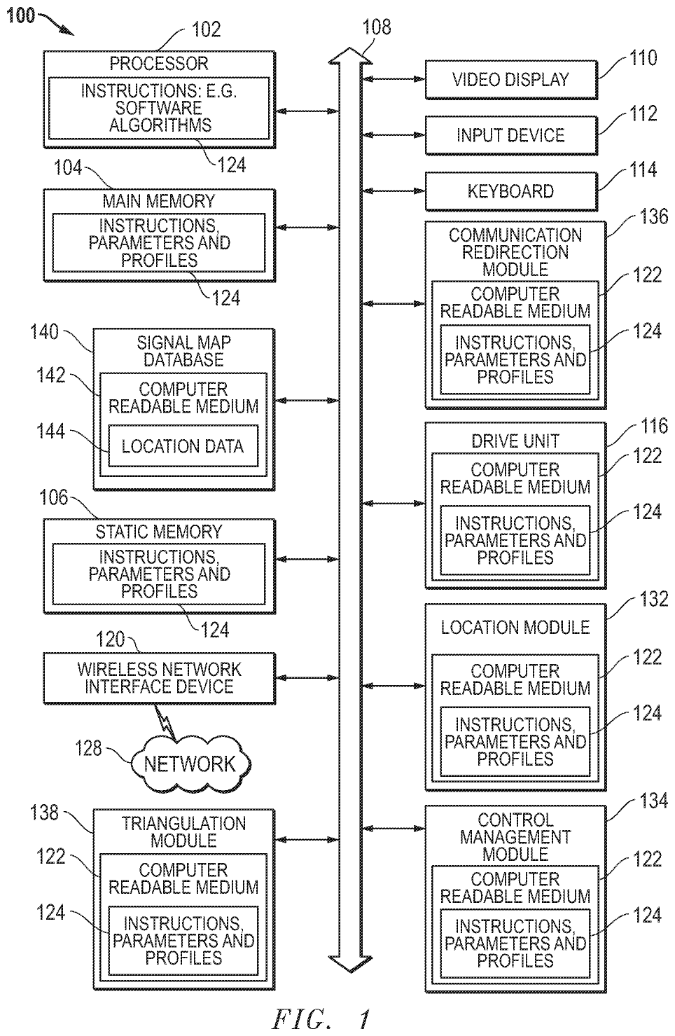

FIG. 1 illustrates an information handling system 100 similar to information handling systems according to several aspects of the present disclosure. In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 can be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP), a base station transceiver, a wireless telephone, a land-line telephone, a control system, a camera, a scanner, a facsimile machine, a printer, a pager, a personal trusted device, a web appliance, or any other suitable machine capable of executing a set of instructions (sequential or otherwise) that specify actions to be taken by that machine, and can vary in size, shape, performance, price, and functionality.

In a networked deployment, the information handling system 100 may operate in the capacity of a server or as a client computer in a server-client network environment, or as a peer computer system in a peer-to-peer (or distributed) network environment. In a particular embodiment, the information handling system 100 can be implemented using electronic devices that provide voice, video or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or multiple sets, of instructions to perform one or more computer functions.

The information handling system can include memory (volatile (e.g. random-access memory, etc.), nonvolatile (read-only memory, flash memory etc.) or any combination thereof), one or more processing resources, such as a central processing unit (CPU), a graphics processing unit (GPU), hardware or software control logic, or any combination thereof. Additional components of the information handling system 100 can include one or more storage devices, one or more communications ports for communicating with external devices, as well as, various input and output (I/O) devices, such as a keyboard, a mouse, a video/graphic display, or any combination thereof. The information handling system 100 can also include one or more buses operable to transmit communications between the various hardware components. Portions of an information handling system 100 may themselves be considered information handling systems 100.

Information handling system 100 can include devices or modules that embody one or more of the devices or execute instructions for the one or more systems and modules described herein, and operates to perform one or more of the methods described herein. The information handling system 100 may execute code instructions 124 that may operate on servers or systems, remote data centers, or on-box in individual client information handling systems according to various embodiments herein. In some embodiments, it is understood any or all portions of code instructions 124 may operate on a plurality of information handling systems 100.

The information handling system 100 may include a processor 102 such as a central processing unit (CPU), control logic or some combination of the same. Any of the processing resources may operate to execute code that is either firmware or software code. Moreover, the information handling system 100 can include memory such as main memory 104, static memory 106, a signal map database 140, computer readable medium 122 storing instructions 124 of a location module 132, a control management module 134, the communication redirection module 136, and the triangulation module 138, and drive unit 116 (volatile (e.g. random-access memory, etc.), nonvolatile (read-only memory, flash memory etc.) or any combination thereof). The information handling system 100 can also include one or more buses 108 operable to transmit communications between the various hardware components such as any combination of various input and output (I/O) devices.

The information handling system 100 may further include a video display 110. The video display 110 in an embodiment may function as a liquid crystal display (LCD), an organic light emitting diode (OLED), a flat panel display, or a solid-state display. Additionally, the information handling system 100 may include an input device 112, such as a cursor control device (e.g., mouse, touchpad, or gesture or touch screen input, and a keyboard 114. The information handling system 100 can also include a disk drive unit 116.

The wireless network interface device 120 as shown in FIG. 1 may include a wireless adapter that can provide connectivity to a network 128, e.g., a wide area network (WAN), a local area network (LAN), wireless local area network (WLAN), a wireless personal area network (WPAN), a wireless wide area network (WWAN), a private LTE communication network, a public LTE communication network, a Wi-Fi communication, a 5G NR communication network, or other networks described herein. Connectivity may be via wired or wireless connection. The wireless network interface device 120 may operate in accordance with any wireless data communication standards. To communicate with a wireless local area network, standards including IEEE 802.11 WLAN standards, IEEE 802.15 WPAN standards, WWAN such as 3GPP or 3GPP2, or similar wireless standards may be used. In some aspects of the present disclosure, one wireless network interface device 120 may operate two or more wireless links.

Wireless network interface device 120 may connect to any combination of macro-cellular and micro-cellular wireless connections including 2G, 2.5G, 3G, 4G, 5G or the like from one or more service providers via any type of access point. In the present specification and in the appended claims, the term “access point” may be defined as any networking hardware device that allows an information handling system to connect to a communication network described herein. In an embodiment, an access point may include a cell tower, a router device, a small cell long-term evolution (LTE) AP, or any other type of physical hardware that is capable of wireless communication to and from the information handling system. Utilization of radiofrequency communication bands according to several example embodiments of the present disclosure may include bands used with the WLAN standards and WWAN carriers, which may operate in both licensed and unlicensed spectrums. For example, both WLAN and WWAN may use the Unlicensed National Information Infrastructure (U-NII) band which typically operates in the ˜5 MHz frequency band such as 802.11 a/h/j/n/ac (e.g., center frequencies between 5.170-5.785 GHz). It is understood that any number of available channels may be available under the 5G NR mm-wave communication frequency bands including those channels associated with frequency range 1 (FR1) and FR2. WLAN, may also operate at a 2.4 GHz band or 5 GHz in other embodiments. WWAN may operate in a number of bands, some of which are proprietary but may include a wireless communication frequency band. In additional examples, WWAN carrier licensed bands may operate at frequency bands of approximately 700 MHz, 800 MHz, 1900 MHz, or 1700/2100 MHz for example as well.

In some embodiments, software, firmware, dedicated hardware implementations such as application specific integrated circuits, programmable logic arrays and other hardware devices can be constructed to implement one or more of some systems and methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a controller or a processor system. Further, in an exemplary, non-limited embodiment, implementations can include distributed processing, component/object distributed processing, and parallel processing. Alternatively, virtual computer system processing can be constructed to implement one or more of the methods or functionalities as described herein.

The present disclosure contemplates a computer-readable medium that includes instructions, parameters, and profiles 124 or receives and executes instructions, parameters, and profiles 124 responsive to a propagated signal, so that a device connected to a network 128 can communicate voice, video or data over the network 128. Further, the instructions 124 may be transmitted or received over the network 128 via the network interface device or wireless network interface device 120.

The information handling system 100 can include a set of instructions 124 that can be executed to cause the computer system to perform any one or more of the methods or computer-based functions disclosed herein. For example, instructions 124 may execute a location module 132, a control management module 134, a communication redirection module 136, a triangulation module 138, software agents, or other aspects or components. Various software modules comprising application instructions 124 may be coordinated by an operating system (OS), and/or via an application programming interface (API). An example operating system may include Windows®, Android®, and other OS types. Example APIs may include Win 32, Core Java API, or Android APIs.

The disk drive unit 116 and the location module 132, control management module 134, communication redirection module 136, and triangulation module 138 may include a computer-readable medium 122 in which one or more sets of instructions 124 such as software can be embedded. Similarly, main memory 104 and static memory 106 may also contain a computer-readable medium for storage of one or more sets of instructions, parameters, or profiles 124 including a signal map database 140. The disk drive unit 116 and static memory 106 may also contain space for data storage. Further, the instructions 124 may embody one or more of the methods or logic as described herein. For example, instructions relating to the location module 132, control management module 134, communication redirection module 136, and triangulation module 138 software algorithms, processes, and/or methods may be stored here. In a particular embodiment, the instructions, parameters, and profiles 124 may reside completely, or at least partially, within the main memory 104, the static memory 106, and/or within the disk drive 116 during execution by the processor 102 of information handling system 100. As explained, some or all of the location module 132, control management module 134, communication redirection module 136, and triangulation module 138 may be executed locally or remotely. The main memory 104 and the processor 102 also may include computer-readable media.

Main memory 104 may contain computer-readable medium (not shown), such as RAM in an example embodiment. An example of main memory 104 includes random access memory (RAM) such as static RAM (SRAM), dynamic RAM (DRAM), non-volatile RAM (NV-RAM), or the like, read only memory (ROM), another type of memory, or a combination thereof. Static memory 106 may contain computer-readable medium (not shown), such as NOR or NAND flash memory in some example embodiments. The location module 132, control management module 134, communication redirection module 136, and triangulation module 138 may be stored in static memory 106, or the drive unit 116 on a computer-readable medium 122 such as a flash memory or magnetic disk in an example embodiment. While the computer-readable medium is shown to be a single medium, the term “computer-readable medium” includes a single-medium or multiple medium, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

As described herein, the information handling system 100 may also include a wireless network interface device 120 used to, in some embodiments, also determine whether the information handling system 100 is communicatively coupled to one of a WiFi communication network, a public long-term evolution (LTE) communication network, a private LTE communication network, a 5G NR communication network, among other types of communication networks. In some embodiments, the wireless network interface device 120 may relay data descriptive of what communication network the information handling system is communicatively coupled to a communication redirection module 136 for further use by the information handling system as described herein.

As described herein, the information handling system 100 may also include a location module 132 that may be operably connected to the bus 108. The location module 132 computer readable medium 122 may also contain space for data storage. The location module 132 may, according to the present description, perform tasks related to determining the location of the information handling system relative to access points within a 4G LTE communication network and a WiFi communication network. As described herein, the location of the access points within a 4G LTE communication network and a WiFi communication network may help to define a location of any 5G NR access points forming a 5G mm-wave communication network. In some embodiments, the 4G LTE communication network and/or WiFi communication network may include a control management module that maintains location data descriptive of the actual physical locations of the 5G NR access points. In some embodiments, the control management modules of the WiFi communication network and 4G LTE communication network may maintain location data descriptive of the physical locations of the 5G NR access points relative to the access points of the 4G LTE communication network and/or WiFi communication network. Depending on the wireless communication network the information handling system is communicatively coupled to, this data may be relayed to the information handling system for use in determining if and when the information handling system may be communicatively coupled to a 5G NR access point associated with a 5G mm-wave communication network.

In an embodiment, the location module 132 may communicate with the main memory 104, the processor 102, the video display 110, the alpha-numeric input device 112, and the wireless network interface device 120 via bus 108, and several forms of communication may be used, including ACPI, SMBus, a 24 MHZ BFSK-coded transmission channel, or shared memory. Driver software, firmware, controllers and the like may communicate with applications on the information handling system 100.

As described herein, the information handling system 100 may also include a control management module 134 that may be operably connected to the bus 108. The control management module 134 computer readable medium 122 may also contain space for data storage. The control management module 134 may, according to the present description, perform tasks related to receiving data descriptive of a location of a 5G new radio (NR) access point relative to the access points within the 4G LTE communication network and the WiFi communication network. As descried herein, this data may be initially received at the wireless network interface device 120 from a control management module of one or both of a 4G LTE communication network and WiFi communication network. Additionally, or alternatively, the control management module 134 may receive data descriptive of an actual location of a 5G NR access point that describes, for example, a GPS location of each 5G NR access point within a 5G mm-wave communication network.

In an embodiment, the control management module 134 may communicate with the main memory 104, the processor 102, the video display 110, the alpha-numeric input device 112, and the wireless network interface device 120 via bus 108, and several forms of communication may be used, including ACPI, SMBus, a 24 MHZ BFSK-coded transmission channel, or shared memory. Driver software, firmware, controllers and the like may communicate with applications on the information handling system 100.

As described herein, the information handling system 100 may also include a communication redirection module 136 that may be operably connected to the bus 108. The communication redirection module 136 computer readable medium 122 may also contain space for data storage. The communication redirection module 136 may, according to the present description, perform tasks related to switching a communication connection from the access point within one of the 4G LTE communication network or WiFi communication network to the 5G NR access point. The communication redirection module 136 may be directed by the control management module 134 to drop a communication between the information handling system 100 and either of an access point associated with the 4G LTE communication network or an access point associated with the WiFi communication network in order to establish a communication between the information handling system 100 and a 5G NR access point within a 5G mm-wave communication network. In the event that the signal from the 5G NR access points reaches a threshold level indicative of a weak signal, the communication redirection module 136 may also direct the communication with the 5G NR access point to be dropped and a new communicative coupling to one of either an access point associated with the 4G LTE communication network or an access point associated with the WiFi communication network.

As described herein, the information handling system 100 may also include a triangulation module 138 that may be operably connected to the bus 108. The triangulation module 138 computer readable medium 122 may also contain space for data storage. The triangulation module 138 may, according to the present description, perform tasks related to iteratively triangulating the position of the information handling system 100 and provide location data to the location module 132 of the information handling system 100. In an embodiment, the triangulation module 138 may receive data descriptive of the location of the information handling system 100 and use that data to determine an actual location of the information handling system 100 or relative location of the information handling system 100 to a 5G NR access points. In an embodiment, the location module 132 may communicatively coupled to a GPS system within the information handling system 100 that provides location data to the triangulation module 138. With the GPS data produced by the GPS system, the information handling system 100 may compare the GPS data with location data descriptive of any number of access points within the 4G LTE communication network and/or WiFi communication network received from the control management modules of the WiFi communication network and 4G LTE communication network in order to determine a relative location of the information handling system 100 to any access point within the 4G LTE communication network or WiFi communication network. Additionally, the triangulation module 138 may also receive data descriptive of a physical location of a 5G NR access points from the control management modules of the WiFi communication network and 4G LTE communication network.

The triangulation module 138 may also include, for example, an accelerometer and a time-of-flight (TOF) module in order to assist in the determination as to the actual or relative location of the information handling system 100 as well as a velocity and/or trajectory of the information handling system 100 at any given point. Each of the GPS system, the accelerometer, and the TOF module may provide location, position, and acceleration data, and therefore, trajectory data, and provide this data to the triangulation module 138. In an embodiment, the information handling system may include an RSSI detection module that detects a received signal strength indicator (RSSI) value, signal-to-noise ratio (SNR), bit error rate (BER), or other signal strength or signal quality measurements at the information handling system from any access point described herein.

In an embodiment, the triangulation module 138 may communicate with the main memory 104, the processor 102, the video display 110, the alpha-numeric input device 112, and the wireless network interface device 120 via bus 108, and several forms of communication may be used, including ACPI, SMBus, a 24 MHZ BFSK-coded transmission channel, or shared memory. Driver software, firmware, controllers and the like may communicate with applications on the information handling system 100.

As described herein, the information handling system 100 may also include a signal map database 140 that may be operably connected to the bus 108. The signal map database 140 computer readable medium 122 may also contain space for data storage. The signal map database 140 may, according to the present description, perform tasks related to signal availability and quality levels while maintaining any location, velocity, and/or trajectory data associated with the information handling system 100 and generated by the triangulation module 138 and/or received by the location module 132 from the control management modules of the WiFi communication network and 4G LTE communication network.

In an embodiment, the signal map database 140 may communicate with the main memory 104, the processor 102, the video display 110, the alpha-numeric input device 112, and the wireless network interface device 120 via bus 108, and several forms of communication may be used, including ACPI, SMBus, a 24 MHZ BFSK-coded transmission channel, or shared memory. Driver software, firmware, controllers and the like may communicate with applications on the information handling system 100.

During operation, the information handling system 100 may initially determine, via execution of the control management module 134 for example, which communication network the information handling system 100 is currently communicatively coupled to. In the embodiments where the information handling system 100 is to be communicatively coupled to a 5G NR access point of a 5G mm-wave communication network, the triangulation module 138 and location module 132 may cooperatively be executed to determine any of an actual location of the information handling system 100, a relative location of the information handling system 100 to the 5G NR access points, the velocity of the information handling system 100 as it moves through an area, and a trajectory of the information handling system 100. Again, GPS systems, accelerometers, gyroscopes, and RSSI detection modules, may be used to determine these actual or relative locations. This data may be compared to any data maintained on the signal map database 140 in order to confirm this information. If the position and trajectory of the information handling system 100 indicates that the information handling system 100 is still in range of the 5G NR access point and the RSSI related to the signal from the 5G NR access point has not fallen below a threshold value, the signal map database 140 may be updated with new location, velocity, and trajectory data, and the process may continue iteratively or continuously.

If the triangulation module 138 and location module 132 indicate that the information handling system 100 is not within range of the 5G NR access point or that the RSSI signal indicates that the signal strength has dropped below the threshold value, the communication redirection module 136 may begin to search for other access points associated with any of the 4G LTE communication network, the WiFi communication network, or the 5G NR access points. In an embodiment, the communication redirection module 136 may prioritize searching for a new 5G NR access point within the 5G mm-wave communication network before searching for any other access points associated with the 4G LTE communication network or WiFi communication network. In an event where a new 5G NR access point is not detected by the communication redirection module 136, the communication redirection module 136 may begin searching for an access point associated with any other available network such as the 4G LTE communication network and the WiFi communication network.

This redirection of the communication to and from an access point of the 5G mm-wave communication network and the information handling system 100 may be accomplished using any process used to disconnect the information handling system 100 from one communication network to another communication network. In an embodiment, the redirection of the network communication from a 4G LTE communication network to a 5G mm-wave communication network may include sending a redirection request signal (e.g., a ping) to, for example, a core network associated with the 4G LTE communication network by the communication redirection module 136. The core network may communicate with a corresponding network device at the 5G mm-wave communication network and may implement any type of authentication processes associated with the information handling system 100 being allowed to communicatively couple to the 5G mm-wave communication network. In these embodiments, the 5G NR access points may be communicatively coupled to the access points of the 4G LTE communication network and may be made available upon request by the information handling system 100.

In other embodiments described herein in connection with the information handling system 100, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

When referred to as a “system”, a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include software, including firmware embedded at a device, such as an Intel® Core class processor, ARM® brand processors, Qualcomm® Snapdragon processors, or other processors and chipsets, or other such device, or software capable of operating a relevant environment of the information handling system. The system, device, controller, or module can also include a combination of the foregoing examples of hardware or software. In an embodiment an information handling system 100 may include an integrated circuit or a board-level product having portions thereof that can also be any combination of hardware and software. Devices, modules, resources, controllers, or programs that are in communication with one another need not be in continuous communication with each other, unless expressly specified otherwise. In addition, devices, modules, resources, controllers, or programs that are in communication with one another can communicate directly or indirectly through one or more intermediaries.

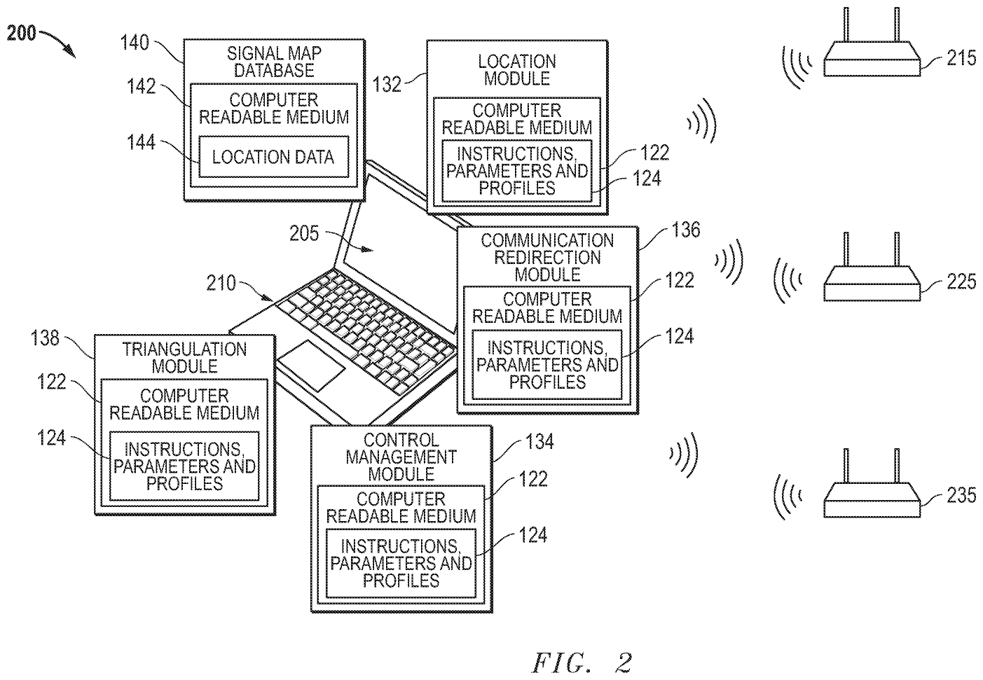

FIG. 2 is a graphical diagram illustrating an information handling system 200 interfacing with a plurality of access points 215, 225, 235 according to an embodiment of the present disclosure. Although FIG. 2 shows that the information handling system 200 is or may be communicatively coupled to three access points 215, 225, 235, the number of access points 215, 225, 235 that the information handling system 200 may be communicatively coupled to either concurrently or sequentially may vary and may, in some embodiments, depend on the number and type of antenna systems within the information handling system 200. For example, the information handling system 200 may include a Bluetooth antenna system, a 5G NR antenna system (e.g., mm-wave antenna system), an LTE antenna system, and a CBRS antenna system, among other types of antenna systems that may establish a communication with an AP 215, 225, 235.

The information handling system 200 of FIG. 2 is shown to be a laptop-type computing device. However, the present specification contemplates that any type of computing device may be used without going beyond the scope of the principles described herein. The information handling system 200, in this embodiment, includes a display portion 205 and a keyboard portion 210. The keyboard portion 210 includes a number of actuatable keys that allows a user to provide input to the information handling system 200. Via interaction with the keyboard portion 210 by a user, the user may input data into the information handling system 200 and receive output from the screen portion 205.

The information handling system 200 includes the location module 132. As described herein, the location module 132 performs tasks related to determining the location of the information handling system relative to access points within a 4G LTE communication network or a WiFi communication network. As described herein, the location of the access points within a 4G LTE communication network or a WiFi communication network may help to define a location of any 5G NR access points forming a 5G mm-wave communication network. In some embodiments, the 4G LTE communication network and/or WiFi communication network may include a control management module that maintains location data descriptive of the actual physical locations of the 5G NR access points. In some embodiments, the control management modules of the WiFi communication network and 4G LTE communication network may maintain location data descriptive of the physical locations of the 5G NR access points relative to the access points of the 4G LTE communication network and/or WiFi communication network. Depending on the wireless communication network the information handling system is communicatively coupled to, this data may be relayed to the information handling system for use in determining if and when the information handling system may be communicatively coupled to a 5G NR access point associated with a 5G mm-wave communication network. In these embodiments, the location module 132 is used to determine a location of the information handling system relative to access points within a 4G LTE communication network and a WiFi communication network and the control management module 134 is used to receive data descriptive of a location of a 5G new radio (NR) access point relative to the access points within the 4G LTE communication network and the WiFi communication network. A control management module 134 and/or communication redirection module 136 then switches a communication connection from the access point within one of the 4G LTE communication network or WiFi communication network to the 5G NR access point.

In an embodiment, a first AP 215 may be associated with a specific type of communication network such as a 5G NR communication network. This would make the first AP 215 a 5G NR-enabled AP 215 that is capable of sending and receiving data packets at a mm-wave frequency. AP 215 is shown as one 5G NR AP, but may be any number of APs supporting 5G NR network connectivity in embodiments herein. As may be appreciated, this mm-wave frequency may include FR 1 and FR 2 frequencies that allow for relatively larger amounts of data to be transmitted across the 5G NR communication network than other types of networks. In the examples where the data to be transmitted includes streaming data, the communicative coupling of the information handling system 200 to this first AP 215 may allow for increased rates of throughput allowing for low-latency transceiving of data to and from the information handling system 200. In order to access the first AP 215, therefore, the information handling system 200 may include a 5G NR antenna system that may include one or more 5G mm wave antennas that may transceive data at the FR1 and FR 2 frequency ranges. However, to prevent the increased power consumption in maintaining the 5G antenna systems of the information handling system 200 at an “on” or “scanning” state, the data received from the other APs 225, 235 associated with the 4G LTE communication network and WiFi communication network, respectively, may be used to provide the information handling system 200 with data descriptive of if and when the information handling system 200 is within signal range of a 5G NR access point.

Where a second AP 225 is associated with a specific type of communication network such as a public or private LTE communication network, the second AP 225 may be an LTE-enabled AP 225 that is capable of sending and receiving data packets at those frequencies associated with LTE transmissions. AP 225 is shown as one LTE-enabled AP, but may be any number of LTE-enabled APs supporting connectivity to one or more LTE networks according to embodiments herein. For example, plural APs 225 may be required for triangulation and position determination according to embodiments herein. As may be appreciated, these frequencies may include a plurality of frequency bands that allow for certain amounts of data to be transmitted across the LTE communication network that has a relatively larger signal range than a 5G NR communication network. In the examples where the data to be transmitted includes data that is dependent on signal quality and reliability, the communicative coupling of the information handling system 200 to this second AP 225 may allow for increased signal reliability during transceiving of data to and from the information handling system 200. In order to access the second AP 225, therefore, the information handling system 200 may include an LTE antenna system that may include one or more LTE wave antennas that may transceive data at those LTE frequency ranges.

During communication with the access points of the 4G LTE communication network, the information handling system 200 may receive data from a control management module associated with the 4G LTE communication network that provides 5G NR access point location data that describes a location of 5G NR access point within a given geographical area. In an embodiment, the location data may be descriptive of an absolute location of each 5G NR access points within the 5G mm-wave communication network. The absolute location may include GPS coordinates, for example, that describes the location of each 5G NR access point regardless of the placement of any other access point or the information handling system 200. In an embodiment, the location data may be descriptive of a relative location of each 5G NR access point within the 5G mm-wave communication network. The relative location may include data descriptive of the location of each of the 5G NR access points within the 5G mm-wave communication network relative to each access point within the 4G LTE communication network and, accordingly, the information handling system 200. In this embodiment, because the triangulation module 138 receives this relative location data and triangulation data from the access points 225 of the 4G LTE communication network, the information handling system 200 may determine the location of the information handling system 200 relative to the 5G NR access points. Triangulation may be conducted via determination of RSSI levels, time of flight (TOF) determinations, or other triangulation techniques to identify a position of the information handling system 200 in the embodiments presented herein. In an embodiment, the information handling system 200 may store the location data related to each of the 5G NR access points on the signal map database 140. This may be done so that as the trajectory and velocity of the information handling system 200 is determined by the triangulation module 138, the information handling system 200 may be communicatively coupled to the 5G NR access point, via the communication redirection module 136, when the information handling system 200 falls within a signal range of the 5G NR access point.

A third AP 235 may be associated with a specific type of communication network such as a public or private Wi-Fi communication network and may be described as a Wi-Fi-enabled AP 235 that is capable of sending and receiving data packets at those frequencies associated with Wi-Fi transmissions. As may be appreciated, these frequencies may include 2.4 GHz and 5 GHz or any other frequencies associated with 802.11b, 802.11a, 802.11g, 802.11n, 802.11ac, and 802.11ax IEEE standards, among others. AP 235 is shown as one Wi-Fi enabled AP, but the present specification contemplates that any number of WiFi enabled APs 235 may be used. For example, plural Wi-Fi enabled APs 235 may be required for triangulation and position determination according to embodiments herein. In order to access the third AP 235 the information handling system 200 may include a Wi-Fi antenna system that may include one or more Wi-Fi wave antennas that may transceive data at those Wi-Fi frequency ranges.

During communication with the access points of the WiFi communication network, the information handling system 200 may receive data from a control management module or other management hardware and software associated with the WiFi communication network that provides 5G NR access point location data that describes a location of 5G NR access point within a given geographical area. In an embodiment, the location data may be descriptive of an absolute location of each 5G NR access points within the 5G mm-wave communication network. The absolute location may include GPS coordinates, for example, that describes the location of each 5G NR access point regardless of the placement of any other access point or the information handling system 200. In an embodiment, the location data may be descriptive of a relative location of each 5G NR access point within the 5G mm-wave communication network. The relative location may include data descriptive of the location of each of the 5G NR access points within the 5G mm-wave communication network relative to each access point within the WiFi communication network and, accordingly, the information handling system 200. In this embodiment, because the triangulation module 138 receives this relative location data and triangulation data from the access points 235 of the WiFi communication network, the information handling system 200 may determine the location of the information handling system 200 relative to the 5G NR access points. In an embodiment, the information handling system 200 may store the location data related to each of the 5G NR access points on the signal map database 140. This may be done so that as the trajectory and velocity of the information handling system 200 is determined by the triangulation module 138, the information handling system 200 may be communicatively coupled to the 5G NR access point, via the communication redirection module 136, when the information handling system 200 falls within a signal range of the 5G NR access point.

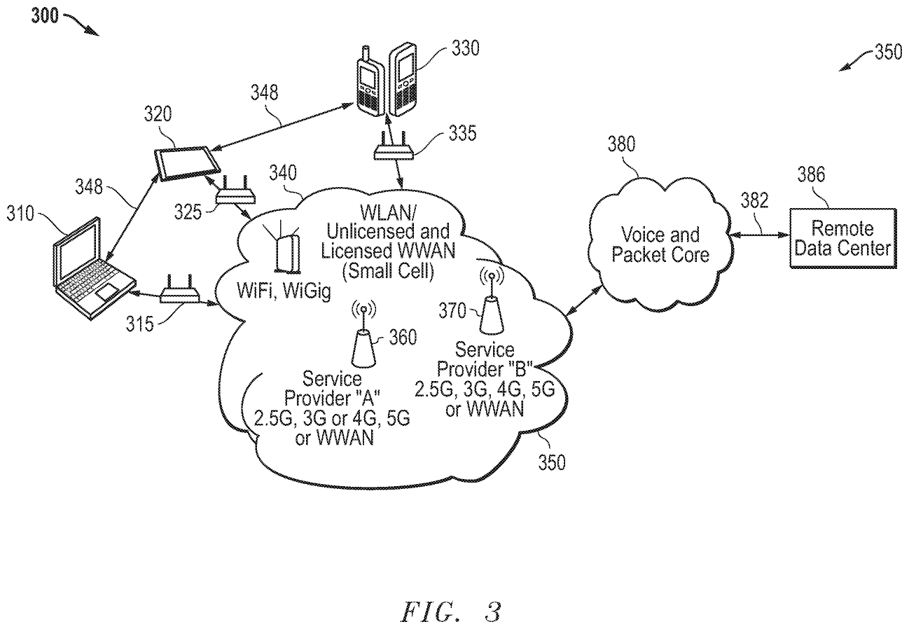

FIG. 3 is a block diagram of a network environment 300 offering several wireless communication protocol options to any type of mobile information handling systems 310, 320, 330 according to an embodiment of the present disclosure. FIG. 3 illustrates a macro- and micro-communication network 300 that may include a plurality of individual communication networks that communicatively couples one or more information handling systems 310, 320, 330 such as the information handling system described in connection with FIG. 1 to one of these communication networks.

In a particular embodiment, network 300 includes networked mobile information handling systems 310, 320, and 330, 5G wireless access points, and multiple wireless connection link options. A variety of additional computing resources of network 300 may include client mobile information handling systems, data processing servers, network storage devices, local and wide area networks, or other resources as needed or desired. As partially depicted, systems 310, 320, and 330 may be a laptop computer, tablet computer, 360-degree convertible systems, wearable computing devices, a smart phone device or other computing devices. These mobile information handling systems 310, 320, and 330, may access a wireless local network 340, or they may access a macro-cellular network 350 via the access points 315, 325, 335. As described herein, the APs 315, 325, 335 may include Wi-Fi-enabled access point, private and public long-term evolution (LTE)-enabled access points, and 5G new radio (NR)-enabled access points and may include a plurality of each to allow for the mobile information handling systems 310, 320, 330 to communicate with the communication networks (e.g., a Wi-Fi communication network, a public LTE communication network, and a private LTE communication network, among others). Although FIG. 3 illustrates three APs 315, 325, 335, the present specification contemplates that the number of APs 315, 325, 335 may be more or less than three in order to form a multi-channel network that includes a Wi-Fi network, a 5G network, and a public and private LTE network, among others. In an example, the wireless local network 340 may be the wireless local area network (WLAN), a wireless personal area network (WPAN), or a wireless wide area network (WWAN). In an example embodiment, LTE-LAA WWAN may operate with a small-cell WWAN wireless access point option.

Components of a wireless local network may be connected by wireline or Ethernet connections to a wider external network. For example, wireless 5G NR-enabled or other local wireless APs 315, 325, 335 may be connected to a wireless network controller and an Ethernet switch. Wireless communications across wireless local network 340 may be via standard protocols such as IEEE 802.11 Wi-Fi, IEEE 802.11ad WiGig, IEEE 802.15 WPAN, or 5G small cell WWAN communications such as gNodeB or eNodeB, IEEE 802.11, IEEE 1914/1904, IEEE P2413/1471/42010, APs 315,325, 335 implementing 802.11b, 802.11a, 802.11g, 802.11n, 802.11ac, and 802.11ax IEEE standards, or similar wireless network protocols developed for 5G, LTE, and Wi-Fi communications.

Alternatively, other available wireless links within network 300 may include macro-cellular connections 350 via one or more service providers 360 and 370. Service provider macro-cellular connections may include 2G standards such as GSM, 2.5G standards such as GSM EDGE and GPRS, 3G standards such as W-CDMA/UMTS and CDMA 2000, 4G standards, or 5G standards including WiMAX, LTE, and LTE Advanced, LTE-LAA, small cell WWAN, and the like. Wireless local network 340 and macro-cellular network 350 may include a variety of licensed, unlicensed or shared communication frequency bands as well as a variety of wireless protocol technologies ranging from those operating in macrocells, small cells, picocells, or femtocells.

In some embodiments according to the present disclosure, a networked mobile information handling system 310, 320, or 330 may have a plurality of wireless network interface systems capable of transmitting simultaneously within a shared communication frequency band. That communication within a shared communication frequency band may be sourced from different protocols on parallel wireless network interface systems or from a single wireless network interface system capable of transmitting and receiving from multiple antenna systems to enhance wireless data bandwidth. Similarly, a single antenna or plural antennas may be used on each of the wireless communication devices so that the beamforming processes may be engaged in as described herein. Example competing protocols may be local wireless network access protocols such as Wi-Fi/WLAN, WiGig, and small cell WWAN in an unlicensed, shared communication frequency band. Example communication frequency bands may include unlicensed 5 GHz frequency bands or 3.5 GHz conditional shared communication frequency bands under FCC Part 96. Wi-Gig ISM frequency bands that could be subject to sharing include 2.4 GHz, 5 GHz and 60 GHz bands or similar bands as understood by those of skill in the art. For embodiments herein, 5G NR frequency bands such as FR1 (e.g., n1-n3, n5, n7, n8, n12, n14, n18, n20, n25, n28-n30, n34, n38-n41, n48, n50, n51, n65, n66, n70, n71, n74-n84, n86, n89, and n90) and FR2 (e.g., n257, n258, n260, and n261) bands may be transceived at the antenna or antennas. Within local portion of wireless network 350 access points for Wi-Fi or WiGig as well as small cell WWAN connectivity may be available in emerging 5G technology. This may create situations where a plurality of antenna systems are operating on a mobile information handling system 310, 320 or 330 via concurrent communication wireless links on both WLAN and WWAN or multiple concurrent wireless link to enhance bandwidth under a protocol and which may operate within the same, adjacent, or otherwise interfering communication frequency bands. The antenna or the individual antennas of an antenna array may be transmitting antennas that includes high-band, medium-band, low-band, and unlicensed band transmitting antennas. Alternatively, embodiments may include a single transceiving antennas capable of receiving and transmitting, and/or more than one transceiving antennas.

The voice and packet core network 380 may contain externally accessible computing resources and connect to a remote data center 386. The voice and packet core network 380 may contain multiple intermediate web servers or other locations with accessible data (not shown). The voice and packet core network 380 may also connect to other wireless networks similar to 340 or 350 and additional mobile information handling systems such as 310, 320, 330 or similar connected to those additional wireless networks. Connection 382 between the wireless network 340 and remote data center 386 or connection to other additional wireless networks may be via Ethernet or another similar connection to the world-wide-web, a WAN, a LAN, or other network structure. Such a connection 382 may be made via an access point/Ethernet switch to the external network and be a backhaul connection. The access point may be connected to one or more wireless access points before connecting directly to a mobile information handling system or may connect directly to one or more mobile information handling systems 310, 320, and 330. Alternatively, mobile information handling systems 310, 320, and 330 may connect to the external network via base station locations at service providers such as 360 and 370. These service provider locations may be network connected via backhaul connectivity through the voice and packet core network 380.

Remote data centers may include web servers or resources within a cloud environment that operate via the voice and packet core 380 or other wider internet connectivity. For example, remote data centers may include additional information handling systems, data processing servers, network storage devices, local and wide area networks, or other resources as needed or desired. Having such remote capabilities may permit fewer resources to be maintained at the mobile information handling systems 310, 320, and 330 allowing streamlining and efficiency within those devices. In an example where the mobile information handling system 310, 320, and 330 includes streaming applications or other high data throughput application, those processing resources at the remote data centers may supplement the high volume of processing used to provide those processes described herein. Similarly, remote data center permits fewer resources to be maintained in other parts of network 300.

Although APs 315, 325, 335 are shown communicatively coupling wireless adapters of mobile information handling systems 310, 320, and 330 to wireless networks 340 or 350, a variety of wireless links are contemplated. Wireless communication may link through a wireless access point (Wi-Fi or WiGig), through unlicensed WWAN small cell base stations such as in network 340 or through a service provider tower such as that shown with service provider A 360 or service provider B 370 and in network 350. In other aspects, mobile information handling systems 310, 320, and 330 may communicate intra-device via 348 when one or more of the mobile information handling systems 310, 320, and 330 are set to act as, for example, a 5G access point or even potentially a WWAN connection via small cell communication on licensed or unlicensed WWAN connections. Concurrent wireless links to information handling systems 310, 320, and 330 may be connected via any access points including other mobile information handling systems as illustrated in FIG. 3. Again, during operation, any of the mobile information handling systems 310, 320, 330, the location module, the control management module, and triangulation module, and communication redirection module described in connection with FIGS. 1 and 2 may cooperate to dynamically, communicatively couple and redirect the mobile information handling systems 310, 320, 330 to and from a WiFi communication network, a public LTE communication network, a private LTE communication network, and a 5G mm-wave communication network, based on the location, trajectory, and/or velocity of the mobile information handling systems.

During operation, the APs 315, 325, 335 may relay data from the 4G LTE communication networks, the WiFi communication networks, and the 5G NR access points descriptive of the location of the information handling system. This data may be used by the location module and control management module in order to determine if and when the information handling system is to be communicatively coupled to a 5G mm-wave communication network. As described herein, the throughput of the 5G mm-wave communication network may increase the data sent from and received by the information handling system thereby increasing the functionalities of the information handling system. In an embodiment, the 5G mm-wave antenna of the information handling system may remain inactive or otherwise in an off state until the communication redirection module has received data from the location module and control management module indicating that the information handling system should be communicatively coupled from a 4G LTE communication network or WiFi communication network to a 5G mm-wave communication network. As described herein, the communication redirection module may give preference to the communicative coupling to the 5G mm-wave communication network when a 5G NR access point is found to be available to the information handling system pursuant to the location, velocity, and/or trajectory of the information handling system.

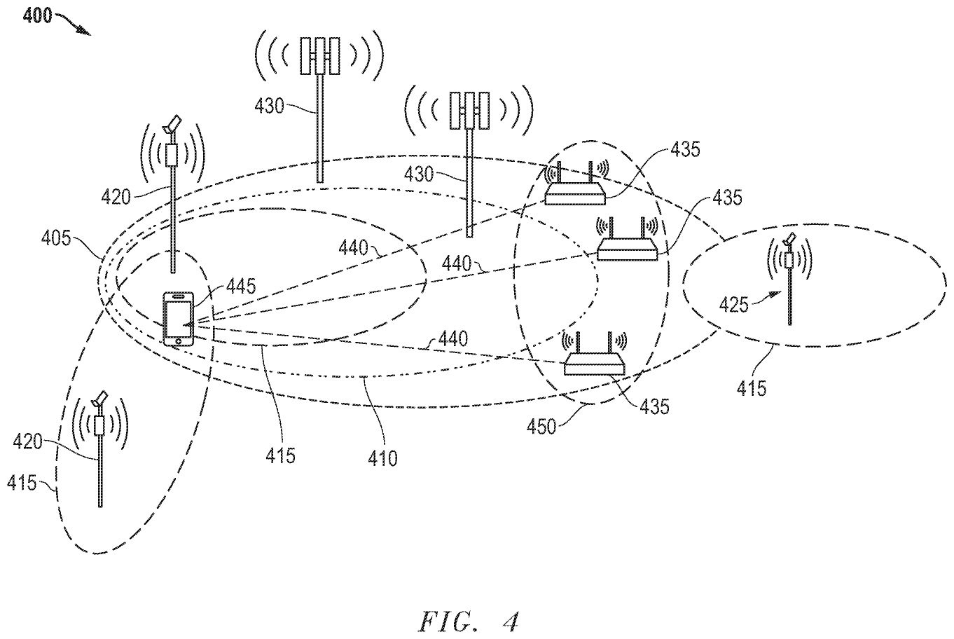

FIG. 4 is a block diagram of a network 400 to redirect a network communication to a 5G NR communication network according to an embodiment of the present disclosure. The network 400 includes a 4G LTE communication network 405 with a sub-6 GHz 5G network 410 and a 5G mm-wave communication network 415. Each of these networks 405, 410, 415 includes its own access point 435 or communication tower 420, 425, 430 that allows the information handling system 445 to be communicatively and selectively coupled to either a 4G LTE communication network, a WiFi communication network. In an embodiment, the 4G LTE communication network 405 may include a plurality of 4G communication towers 430 that allows for the triangulation data descriptive of a location of the information handling system 445 to be transmitted to the location module of the information handling system 445. The location data may be processed by the triangulation module and compared to any internal data descriptive of the location of the information handling system 445.

Similarly, the WiFi communication network 450 may include a plurality of access points 435. The plurality of access points 435 of the WiFi communication network 450 allow for the triangulation data descriptive of a location of the information handling system 445 to be transmitted to the location module of the information handling system 445. The location data may be processed by the triangulation module and compared to any internal data descriptive of the location of the information handling system 445. The triangulation data may be computed using, for example, a received signal strength indicator (RSSI) 440, phase shift, ToF, or other measurable aspect to determine distance or angle received at the information handling system 445 or access points 435 among other data described herein. In an embodiment, the triangulation data may be computed using AP triangulation processes that includes receiving a connection signal from the three different APs (e.g., cell towers) at the information handling system 445 determining a point of overlap of distance radius of the three signals. At this point, the information handling system 445 may broadcast its location to any AP within any network.

During operation, the information handling system 445 may be redirected from one of the 4G LTE communication network 405 or WiFi communication network 450 to the 5G mm-wave communication network 415. The 5G mm-wave communication network 415 may be one of a macrocell 5G communication tower 420 or a small cell 5G communication tower 425. In either example, the information handling system 445 may anticipate the movement into a 5G mm-wave communication network 415 and automatically redirect the communication from the WiFi communication network 450, the sub-6 GHz 5G network 410, or the 4G LTE communication network 405 to the 5G mm-wave communication network 415.

In embodiments herein, the information handling system may implement any process, method, or algorithm in order to cause radio frequency (RF) electromagnetic (EM) waves emitted by a mm-wave antenna array at the information handling system to be directed to a 5G access point for the mm-wave communication link. In some embodiments, determining whether any other 5G NR access point is within range of the information handling system may further include scanning for 5G NR access points which may require energy and processing. Further, with a 5G mm-wave antenna array on an information handling system or access point, 5G NR connectivity may require conducting a beamsweeping process at a plurality of angles out from the information handling system for a 5G new radio (NR) access point due to the shorter range of 5G NR frequency operation. Such a beamsweeping process may be power consuming and may also consume processing power. Accordingly, processes according to embodiments herein may utilize existing Wi-Fi, 4G, or other 5G networks to determine a target 5G NR network access point location relative to an information handling system. Such networks may have greater range and require less power to identify locations of 5G NR access points before an information handling system conducts a scanning and beamsweeping process to search for such an access point.

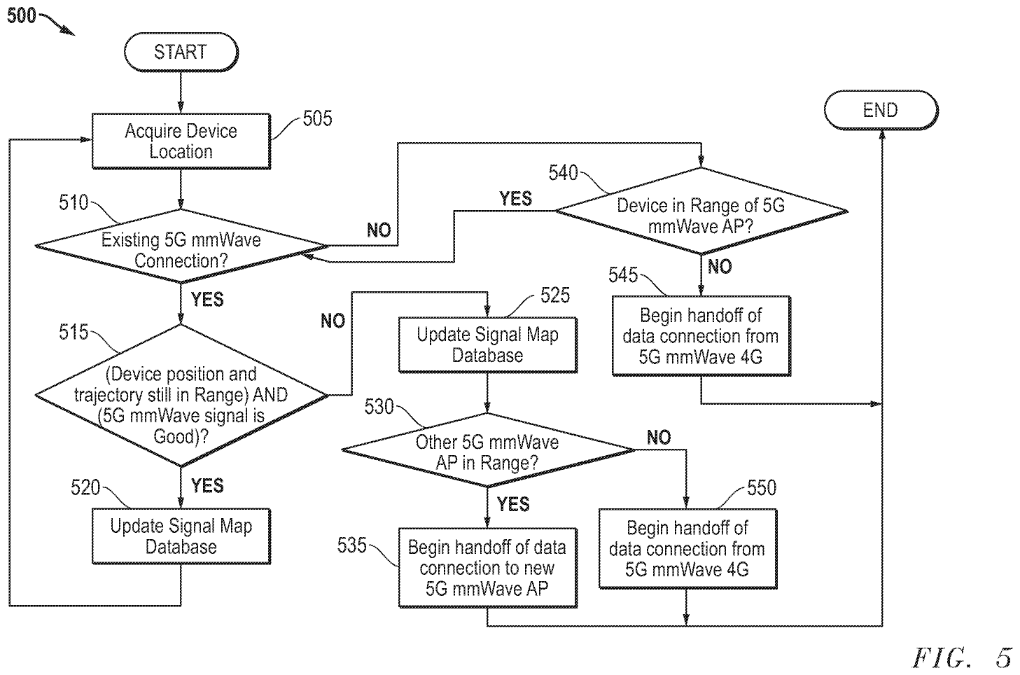

FIG. 5 is a flow diagram illustrating a method of prioritizing communication with a 5G NR communication network according to an embodiment of the present disclosure. The method 500 may begin with acquiring, at block 505, the location of the information handling system. Again, the location of the information handling system may be determined using the location module and control management module of the information handling system described herein. In an embodiment, a control management module associated with a WiFi communication network or a 4G LTE communication network may transmit data descriptive of the location of the information handling system. In an embodiment, the access points of the 4G LTE communication network, the sub-6 GHz 5G network, and the WiFi communication network may be used to triangulate the location of the information handling system within a geographical area. This data may also include data descriptive of the location of at least one 5G NR access point relative to the access points of the 4G LTE communication network, the sub-6 GHz 5G network, and the WiFi communication network. The information handling system may also include its own triangulation module that iteratively triangulates the location of the information handling system and provides location data to the location module of the information handling system. In an embodiment, the information handling system may further include an accelerometer and a gyroscope communicatively coupled to the location module to determine a trajectory of the information handling system relative to the access points within the 4G LTE communication network and the WiFi communication network. In an embodiment, the information handling system may also include a signal strength detection module to detect a signal strength between the information handling system and the 5G NR access point.

The method 500 may further include determining, at block 510, whether the information handling system is communicatively coupled to a 5G mm-wave communication network. In an embodiment, the wireless network interface device of the information handling system may be used to make this determination at block 510. When the information handling system determines that it is communicatively coupled to a 5G mm-wave communication network (YES determination at block 510, the method 500 may continue with determining, at block 515, that the position and trajectory of the information handling system is within range of a 5G NR access point of the 5G mm-wave communication network and that the signal strength from the 5G NR access point is above a threshold limit. The signal strength may be quantified by a RSSI value measured at an RSSI detection module of the information handling system. When the position of the information handling system is within a signal range of the 5G NR access point and the signal quality is above a threshold RSSI value (YES determination at block 515), a signal map database of the information handling system may be updated at block 520 with any change in location of the information handling system and the method 500 may continue with, again, acquiring the location of the information handling system at block 505. In an embodiment, the signal map database may include data descriptive of location of any number of APs within range of the information handling system. This signal map database may also include data descriptive of x-,y-, and z-coordinates of each AP within, for example a building. This data may be stored in a remote data center and/or may be duplicated on an edge compute in a core network. In an embodiment, the data associated with the signal map database may be stored on the information handling system. As the information handling system passes through any given geographical location, the signal map database may be augmented by a learning algorithm that learns, empirically, over time the signal quality of each AP at any given geographic location.

When the information handling system determines at block 515 that either the position and trajectory of the information handling system has fallen out of range of the 5G NR access point or the measured signal strength between the information handling system and 5G NR access point falls below a threshold RSSI value (NO determination, block 515), the method 500 may continue with updating the signal map database at block 525 and determining whether any other 5G NR access point is within range of the information handling system. As described herein, the information handling system may give preference to the communicative coupling of the information handling system to a 5G mm-wave communication network over any other type of communication network available to the information handling system. Per an embodiment described herein, a communication redirection module may begin to search for other access points associated with any of the 4G LTE communication network, the WiFi communication network, or the 5G NR access points. In an embodiment, the communication redirection module may prioritize searching for a new 5G NR access point within the 5G mm-wave communication network before searching for any other access points associated with the 4G LTE communication network or WiFi communication network. The information handling system may implement any process, method, or algorithm in order to cause radio frequency (RF) electromagnetic (EM) waves emitted by a mm-wave antenna array at the information handling system to be directed to a 5G access point for the mm-wave communication link. In an embodiment, determining whether any other 5G NR access point is within range of the information handling system may further include, with a 5G mm-wave antenna array, conducting a beamsweeping process at a plurality of angles out from the information handling system for a 5G new radio (NR) access point. The process may further include using the angle data as an initial seed angle for the beamsweeping process. In this embodiment, an initial beamforming algorithm for conducting a beamsweeping by the 5G mm-wave antenna array may operate to iteratively assess angles in various zones and compare those spot-checked angles with the initial seed angle zone to find a suitable beamsteering pattern and directionality. With the initial seed angle, zones of angles may be eliminated by comparison thus potentially reducing several among thousands of potential angles to be scanned in a beamsweeping algorithm.

Where it is determined that another 5G NR access point is available and within range of the information handling system (YES determination at block 530), the method 500 may continue with initiating a handoff process in order to establish a new 5G mm-wave communication with the new 5G NR access point at block 535. As described herein, the 5G mm-wave communication network may include a plurality of 5G NR access points whose physical location is known via acquiring such location data from the access points at the 4G LTE communication network, the WiFi communication network, or the sub-6 GHz 5G network and storing the location data on the signal map database as described herein. The method 500 may then end.

Where it is determined that another 5G NR access point is not available and within range of the information handling system (NO determination at block 530), the method 500 may continue with beginning a redirection from the 5G mm-wave communication network to one of a 4G LTE communication network, a sub-6 GHz 5G network, or a WiFi communication network at block 550. The method 500 may then end.

Where it is determined that the information handling system is not communicatively coupled to a 5G mm-wave communication network (NO determination at block 510), the method 500 may continue at block 540 with determining whether any 5G NR access point is within range of the information handling system. Again, the information handling system may give preference to the communicative coupling of the information handling system to a 5G mm-wave communication network over any other type of communication network available to the information handling system. Where a 5G NR access point is within signal range of the information handling system (YES determination at block 540), the method 500 may proceed to block 510, with monitoring iteratively or continuously whether an existing 5G mmwave connection is established and whether either the position and trajectory of the information handling system has fallen out of range of the 5G NR access point or the measured signal strength between the information handling system and 5G NR access point falls below a threshold RSSI value. Where a 5G NR access point is not within signal range of a 5G NR access point (NO determination at block 540), the method 500 may include beginning a redirection from the 5G mm-wave communication network to one of a 4G LTE communication network, a sub-6 GHz 5G network, or a WiFi communication network at block 545. At this time the method 500 may end.

As is described in the present specification, the information handling system may be communicatively coupled to any of a plurality of communication networks based on the location of the information handling system with a 5G mm-wave communication network being preferred in the systems and methods. During operation, the wireless network interface device may determine whether a 5G mm-wave communication network is available and, if not, communicatively couple the information handling system to another communication network such as a 4G LTE communication network, a sub-6 GHz 5G network, or a WiFi communication network. This communication network prioritization described herein allows the information handling system to maintain a 5G antenna system in an off state until a 5G NR access point has been made available thereby saving power consumed by, what would otherwise be, a continuous scan for the 5G NR access points of a 5G mm-wave communication network.

The blocks of the flow diagrams of FIG. 5 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

1. An information handling system, comprising:
a processor and controller;
a memory device;
a wireless network interface device;
the processor or controller executing instructions of a location module to determine a location of the information handling system relative to access points within a 4G LTE communication network and a WiFi communication network via multi-lateration in the 4G LTE communication network and the WiFi communication network;
the processor or controller executing instructions of a control management module to seek a 5G new radio (NR) access point by receiving, via the 4G LTE communication network or the WiFi communication network, data descriptive of a location of the 5G NR access point relative to the access points within the 4G LTE communication network and the WiFi communication network;
the processor or controller executing instructions of the control management module to determine that the location of the information handling system is within a signal range distance to the location of the 5G NR access point before commencing scanning for 5G NR wireless links to save power consumption;
the processor or controller executing instructions of a communication redirection module configured to commence scanning for the 5G NR access point and to determine signal level of the 5G NR access point after determining that the 5G NR access point is within a signal range distance via the 4G LTE communication network and the WiFi communication network; and
the communication redirection module to switch a communication connection from the access point within one of the 4G LTE communication network and WiFi communication network to the 5G NR access point when the 5G NR wireless link signal level meets a sufficient threshold.

2. The information handling system of claim 1, further comprising a global positioning system (GPS) communicatively coupled to the location module to measure the position of the information handling system.

3. The information handling system of claim 1, further comprising the processor or controller executing instructions of a triangulation module to iteratively triangulate the location of the information handling system and provide location data to the location module of the information handling system.

4. The information handling system of claim 1, wherein the location module determines the location of the information handling system by receiving location data from an access point within the 4G LTE communication network or the WiFi communication network that the information handling system is currently communicatively coupled to.

5. The information handling system of claim 1, further comprising an accelerometer and a gyroscope communicatively coupled to the location module to determine a trajectory of the information handling system relative to the access points within the 4G LTE communication network and the WiFi communication network.

6. The information handling system of claim 1, further comprising a signal map database to maintain location data descriptive of the location of the information handling system relative to the access points within the 4G LTE communication network and the WiFi communication network.

7. The information handling system of claim 1, further comprising, with a 5G mm-wave antenna array, conducting a beamsweeping process at a plurality of angles out from the information handling system for a 5G new radio (NR) access point and using angle data determined from the location of the information handling system relative to the location of the 5G NR access point descriptive data as an initial seed angle for the beamsweeping process.

8. The information handling system of claim 7, wherein, when the signal strength detection module detects a signal strength between the information handling system and the 5G NR access point is below a threshold a received signal strength indicator (RSSI) level, the wireless network interface device searches for:
another 5G NR access point available for communication;
an access point associated with the 4G LTE communication network; or
an access point associated with the WiFi communication network.

9. The information handling system of claim 1, wherein the location module receives data from a control manager at one of the 4G LTE communication network and the WiFi communication network descriptive of a location of the 5G NR access point within a signal range of an access point of the 4G LTE communication network or the WiFi communication network.

10. A method of prioritizing communication with a 5G new radio (NR) communication network for an information handling system, comprising:
with a processor or controller executing instructions of a location module, determining a location of the information handling system relative to access points within a 4G LTE communication network and a WiFi communication network;
with the processor or controller executing instructions of a control management module, seeking a 5G new radio (NR) access point by receiving, via the 4G LTE communication network or the WiFi communication network, data descriptive of a location of a 5G new radio (NR) access point relative to the access points within the 4G LTE communication network and the WiFi communication network;
with the processor or controller executing instructions of the control management module, determining whether the location of the information handling system is within a signal range distance to the location of the 5G NR access point before commencing scanning for 5G NR wireless links to save power consumption; and
with the processor or controller executing instructions of a communication redirection module, scanning for the 5G NR access point and to determine signal strength of the 5G NR access point after determining that the 5G NR access point is within a signal range distance and switching a communication connection from the access point within one of the 4G LTE communication network and WiFi communication network to the 5G NR access point when the signal strength of the 5G NR access point is sufficient to support a 5G NR wireless link.

11. The method of claim 10, further comprising receiving data from a global positioning system (GPS) communicatively coupled to the location module to measure the position of the information handling system.

12. The method of claim 10, further comprising with the processor or controller executing instructions of a triangulation module by the processor, iteratively triangulating the location of the information handling system and providing location data to the location module of the information handling system.

13. The method of claim 10, further comprising determining the location of the information handling system via the location module by receiving location data from an access point within a 4G LTE communication network and a WiFi communication network that the information handling system is currently communicatively coupled to.

14. The method of claim 10, wherein determining a trajectory of the information handling system relative to the access points within the 4G LTE communication network or the WiFi communication network is done by an accelerometer and a gyroscope communicatively coupled to the location module.

15. The method of claim 14, further comprising the processor or controller executing instructions of a signal strength detection module to determine a signal strength between the information handling system and the 5G NR access point via execution of a signal strength detection module.

16. The method of claim 15, further comprising, when the signal strength detection module detects a signal strength between the information handling system and the 5G NR access point is below a threshold received signal strength indicator (RSSI) level, searching for, via execution of a wireless network interface device:
another 5G NR access point available for communication;
an access point associated with the 4G LTE communication network; or
an access point associated with the WiFi communication network.

17. An information handling system, comprising:
a processor and a controller;
a memory device;
a wireless network interface device to communicatively couple the information handling system to a communication network;
the processor or controller executing instructions of a location module to determine via triangulation a location of the information handling system relative to access points within a 4G LTE communication network and a WiFi communication network;
the processor or controller executing instructions of a control management module to seek a 5G new radio (NR) access point by receiving, via the 4G LTE communication network or the WiFi communication network, data descriptive of a location of the 5G NR access point relative to the access points within the 4G LTE communication network and the WiFi communication network;
the processor or controller executing instructions of the control management module to determine that the location of the information handling system is within a signal range distance to the location of the 5G NR access point before commencing scanning for 5G NR wireless links to save power consumption;
the processor or controller executing instructions of a communication redirection module to switch a communication connection from the access point within one of the 4G LTE communication network and the WiFi communication network to the 5G NR access point; and
the processor or controller executing instructions of the control management module to update a signal map database to maintain location data descriptive of the location of the 5G NR access point signal distance range to the information handling system relative to the access points within a 4G LTE communication network and a WiFi communication network.

18. The information handling system of claim 17, further comprising a global positioning system (GPS) communicatively coupled to the location module to measure the position of the information handling system.

19. The information handling system of claim 17, wherein the location module determines the location of the information handling system by receiving location data from an access point within the 4G LTE communication network or the WiFi communication network that the information handling system is currently communicatively coupled to.

20. The information handling system of claim 17, further comprising the processor or controller executing instructions of a signal strength detection module to detect a signal strength between the information handling system and the 5G NR access point.
